(19) United States
(12) Patent Application Publication
(10) Pub. No.: US 2026/0024255 A1
(43) Pub. Date: Jan. 22, 2026

(54) EFFECT PROCESSING METHOD, ELECTRONIC DEVICE AND NON-TRANSITORY STORAGE MEDIUM

(71) Applicants: Lemon Inc., Grand Cayman (KY); BEIJING ZITIAO NETWORK TECHNOLOGY CO., LTD., Beijing (CN)

(72) Inventors: Haibin HUANG, Los Angeles, CA (US); Chongyang MA, Los Angeles, CA (US); Yunzhu LI, Los Angeles, CA (US); Lezhou FENG, Los Angeles, CA (US); Chenliang ZHANG, Beijing (CN)

(21) Appl. No.: 19/270,918

(22) Filed: Jul. 16, 2025

(30) Foreign Application Priority Data
Jul. 19, 2024 (CN) 202410976851.3

(51) Int. Cl. G06T 11/60; G06T 5/60; G06T 11/00

(52) U.S. Cl. CPC G06T 11/60; G06T 5/60; G06T 11/001; G06T 2207/20081; G06T 2207/20084

(57) ABSTRACT

The present disclosure relates to an effect processing method, an electronic device and a non-transitory storage medium. The effect processing method includes: in response to an effect processing request input on a mobile terminal, acquiring an image to be processed; and performing effect processing on the image to be processed by a first generation model deployed on the mobile terminal to obtain a target effect image, and displaying the target effect image; the first generation model is obtained by training a first generative adversarial network, at least part of training data of the first generative adversarial network is generated by a second generation model deployed on a server, and the second generation model is obtained by training a second generative adversarial network.

### CROSS-REFERENCE TO RELATED APPLICATION

This application claims the priority to and benefits of the Chinese Patent Application No. 202410976851.3, which was filed on Jul. 19, 2024. The aforementioned patent application is hereby incorporated by reference in its entirety.

### TECHNICAL FIELD

Embodiments of the present disclosure relate to an effect processing method, an electronic device and a non-transitory storage medium.

### BACKGROUND

In a scene of image processing or video production, an application of effects is favored by users. The users may process an image or video with a selected effect so that an obtained effect image presents an effect outcome corresponding to the effect.

In a related art, when a mobile terminal requests an effect processing, due to a computing power limitation of the mobile terminal, there may be a problem of a slow response rate to an effect processing request, or a poor effect outcome of the processed effect image, thereby affecting user experience of the effect.

### SUMMARY

The application provides an effect processing method, an electronic device and a non-transitory storage medium, so as to improve the response efficiency of effect requests and the presented effect.

An embodiment of the present disclosure provides an effect processing method, which includes:
in response to an effect processing request input on a mobile terminal, acquiring an image to be processed; and
performing effect processing on the image to be processed by a first generation model deployed on the mobile terminal to obtain a target effect image, and displaying the target effect image;
the first generation model is obtained by training a first generative adversarial network, at least part of training data of the first generative adversarial network is generated by a second generation model deployed on a server, and the second generation model is obtained by training a second generative adversarial network.

An embodiment of the present disclosure provides an effect processing apparatus, which includes:
an effect requesting module, configured to, in response to an effect processing request input on a mobile terminal, acquire an image to be processed;
an effect processing module, configured to perform effect processing on the image to be processed by a first generation model deployed on the mobile terminal to obtain a target effect image, and display the target effect image; the first generation model is obtained by training a first generative adversarial network, at least part of training data of the first generative adversarial network is generated by a second generation model deployed on a server, and the second generation model is obtained by training a second generative adversarial network.

An embodiment of the present disclosure provides an electronic device, which includes:
one or more processors;
a storage apparatus configured to store one or more programs,
the one or more programs, when executed by the one or more processors, cause the one or more processors to implement the effect processing method according to any one of the embodiments of the present disclosure.

An embodiment of the present disclosure provides a storage medium containing computer-executable instructions, which, when executed by a computer processor, perform the effect processing method according to any one of the embodiments of the present disclosure.

An embodiment of the present disclosure provides a computer program product, which includes a computer program, and the computer program, when executed by a processor, implements the effect processing method according to any one of embodiments of the present disclosure.

### BRIEF DESCRIPTION OF DRAWINGS

The above and other features, advantages, and aspects of each embodiment of the present disclosure may become more apparent by combining the accompanying drawings and referring to the following specific implementation modes. In the drawings throughout, same or similar reference numerals represent same or similar elements. It should be understood that the drawings are schematic, and originals and elements may not necessarily be drawn to scale.

FIG. 1 is a flow chart of an effect processing method according to an embodiment of the present disclosure;

FIG. 2 is a model structure diagram of a second generation model for an effect processing method according to an embodiment of the present disclosure;

FIG. 3 is a flow chart of another effect processing method according to an embodiment of the present disclosure;

FIG. 4 is a structural schematic diagram of an effect processing apparatus according to an embodiment of the present disclosure; and

FIG. 5 is a structural schematic diagram of an electronic device according to an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the drawings and the embodiments of the present disclosure are only for exemplary purposes, and are not intended to limit the scope of protection of the present disclosure.

It should be understood that the various steps described in the method embodiments of the present disclosure may be performed in different orders, and/or performed in parallel. Furthermore, additional steps may be included and/or the execution of the illustrated steps may be omitted in the method embodiments. The scope of the present disclosure is not limited in this respect.

The term “include/comprise” used herein and the variations thereof are an open-ended inclusion, namely, “include/comprise but not limited to”. The term “based on” means “at least partially based on”. The term “an embodiment” means “at least one embodiment”. The term “another embodiment” means “at least one another embodiment”. The term “some embodiments” means “at least some embodiments”. Related definitions of the other terms will be given in the description below.

It should be noted that concepts such as “first,” “second,” etc. mentioned in the present disclosure are only used to distinguish different apparatuses, modules, or units, and are not intended to limit orders or interdependence relationships of functions performed by these apparatuses, modules, or units.

It should be noted that modifications of “one” and “more” mentioned in the present disclosure are schematic rather than restrictive, and those skilled in the art should understand that otherwise explicitly stated in the context, it should be understood as “one or more”.

The names of messages or information exchanged between a plurality of apparatuses in the embodiments of the present disclosure are used for illustrative purposes only, and are not indicated to limit the scope of these messages or information.

It may be understood that before using the technical solutions disclosed in the embodiments of the present disclosure, the types, scope of use, and usage scenarios of personal information involved in the present disclosure and the like shall be informed to the user and the user's authorization shall be obtained in an appropriate manner in accordance with relevant laws and regulations.

For example, when receiving an active request from a user, a prompt message is sent to the user to explicitly prompt the user that an operation requested by the user will need to obtain and use the user's personal information. In this way, the user can choose whether to provide personal information to a software or hardware such as an electronic device, an application, a server, or a storage medium that performs the operation of the technical solution of the present disclosure according to the prompt message.

As an optional but non-limiting implementation, in response to receiving an active request from a user, the prompt message may be sent to the user in the form of a pop-up window, and the prompt message may be presented in the pop-up window in the form of text. In addition, the pop-up window may also carry a selection control for the user to select “agree” or “disagree” to provide personal information to the electronic device.

It may be understood that the above process of notifying and obtaining user authorization is only schematic, and does not limit the implementation of the present disclosure. Other manners that meet relevant laws and regulations may also be applied to the implementation of the present disclosure.

It may be understood that the data (including but not limited to the data itself, data acquisition or use) involved in the technical solutions of the present disclosure shall comply with the requirements of the corresponding laws, regulations, and related provisions.

FIG. 1 is a flow chart of an effect processing method according to an embodiment of the present disclosure. The embodiment of the present disclosure is applicable to a case where an effect processing is performed on an acquired image to be processed on a mobile terminal. The method may be performed by an effect processing apparatus, which may be implemented in a form of software and/or hardware, and optionally, by an electronic device, which may be a mobile terminal, a PC or a server, etc.

As shown in FIG. 1, the method of this embodiment may specifically include steps of S110 and S120.

At S110, in response to an effect processing request input on a mobile terminal, acquiring an image to be processed.

The effect processing request may be understood as an instruction for requesting to perform an effect processing to an image. The effect processing request may include a variety of input manners. Optionally, when a trigger operation input by a user for an effect processing control preset on the mobile terminal is detected, it may be determined that the effect processing request input on the mobile terminal is received; alternatively, when it is detected that audio information received by the mobile terminal includes trigger words associated with the effect processing, it may be determined that the effect processing request input on the mobile terminal is received; alternatively, when it is detected that the user inputs an effect processing instruction on the mobile terminal, it may be determined that the effect processing request input on the mobile terminal is received. The image to be processed may be an image to be performed an effect processing. Optionally, the image to be processed may be a default template image, an image acquired based on a terminal device, an image acquired from a target storage space (such as an image library of an application software, or a local terminal album, etc.) in response to a user's trigger operation, or an image uploaded by an external device, etc. The terminal device may refer to an electronic device with an image capture function, such as a camera, a smart phone, and a tablet computer.

It should be noted that the mobile terminal that obtains the image to be processed may be a terminal device that supports an effect processing to the image, for example, a mobile terminal registered in an application software with an effect processing function, or a mobile terminal registered in an application software with an effect prop production function, which is not specifically limited in the embodiment of the present disclosure.

In the embodiment of the present disclosure, when the mobile terminal receives an effect processing request input on the mobile terminal, it can respond to the effect processing request. Furthermore, the image to be processed for effects may be obtained based on the effect processing request.

According to an optional implementation of the embodiments of the present disclosure, when a trigger operation input by a user for an effect processing control preset on the mobile terminal is detected, it may be determined that the effect processing request input on the mobile terminal is received. Furthermore, the effect processing request is responded to, and a shooting interface is entered; at this time, a picture displayed on the shooting interface is a picture in a field of view of a shooting device. Further, when an image shooting operation is detected, an image displayed on the current shooting interface may be captured by the shooting device, and the captured image is used as the image to be processed.

At S120, performing effect processing on the image to be processed by a first generation model deployed on the mobile terminal to obtain a target effect image, and displaying the target effect image.

In the embodiment of the present disclosure, the first generation model may be understood as a neural network model that takes an image as an input object, performs stylized effect processing on the image, and outputs an image with a specific stylized effect. The first generation model may be a neural network model of any model structure. For example, the first generation model may be a Generative Adversarial Network (GAN).

In a practical application, an amount of computation required for effect processing of an image is large, and the image to be processed is often processed based on an effect image generation model deployed on the server. Furthermore, the obtained effect image is fed back to the mobile terminal. Such a processing manner may result in a case that an effect processing efficiency is low. In addition, if the quality of training data used in training the effect image generation model is low, the generated effect is unstable and poor when the effect is processed based on the effect image generation model.

In view of the above case, in the embodiment of the present disclosure, the first generation model may be deployed on the mobile terminal, and furthermore, when the mobile terminal obtains an image to be processed, the image to be processed may be directly subjected to effect processing based on the deployed first generation model to obtain a target effect image. It should be noted that, in order to adapt to a computing power of the mobile terminal, the first generation model may be a lightweight neural network model. Moreover, in order to improve stability and image quality of the effect image output by the first generation model, at least part of the training data used to train the first generation model may be generated by a second generation model deployed on the server.

In a practical application, different mobile terminals may correspond to different computing power. If the first generation model of a same model structure is deployed on different mobile terminals, the computing power of some mobile terminals may not meet computing requirements of the first generation model, thereby causing the mobile terminal to lag during the effect processing.

In view of the above case, in the embodiment of the present disclosure, in order to make the mobile terminal more adaptable to the deployed first generation model, the model structure of the first generation model may be associated based on a target parameter of the mobile terminal. The target parameter may be used to represent the computing power of the mobile terminal. An advantage of such arrangement is that the computing power of the mobile terminal can meet operation requirements of the first generation model of the corresponding model structure, thereby achieving an outcome of improving the image processing efficiency on the basis of ensuring the effect of generating effect images, and improving an effect processing experience of mobile terminal users. The target parameter may include a variety of parameters that can represent the computing power of the mobile terminal. Optionally, the target parameter includes at least an image resolution corresponding to the mobile terminal and/or a number of floating point operations performed per second. The model structures of the first generation models deployed by mobile terminals with different image resolutions may be different. Generally, the image resolutions corresponding to the mobile terminals may include multiple levels, and mobile terminals with a same image resolution level may deploy first generation models with the same model structure.

For example, it is assumed that the image resolution levels corresponding to the mobile terminals may include 512×512 pixels, 384×384 pixels, and 256×256 pixels. Mobile terminals with an image resolution of 512×512 pixels may deploy the first generation models with a same model structure; mobile terminals with an image resolution of 384×384 pixels may deploy the first generation models with the same model structure; mobile terminals with an image resolution of 256×256 pixels may deploy the first generation models with the same model structure. It may be appreciated that when there are other factors that represent the computing power of the mobile terminal (such as the number of floating point operations performed per second), mobile terminals with the same image resolution level may also deploy first generation models with different model structures, which is not specifically limited in the embodiment of the present disclosure.

The number of floating-point operations per second (FLOPS) is a measure of how many floating-point operations a computer or processor can complete per second. The model structures of the first generation models deployed by mobile terminals with different FLOPS may be different. Generally, the FLOPS corresponding to the mobile terminals may include multiple levels, and mobile terminals with the same FLOPS may deploy the first generation models with the same model structure. Alternatively, the mobile terminals with the same FLOPS may also deploy first generation models with different model structures.

In the embodiment of the present disclosure, the first generation model is obtained by training a first generative adversarial network, and at least part of training data of the first generative adversarial network is generated by a second generation model deployed on the server.

As an optional implementation of an embodiment of the present disclosure, before performing effect processing on the image to be processed by the first generation model deployed on the mobile terminal, the first generative adversarial network pre-established may be trained first. A training process of the first generation model may be: acquiring a second sample image; performing effect processing on the second sample image based on the second generation model to obtain a second effect image, and based on the second sample image and its corresponding second effect image, constructing training data for training the first generative adversarial network; and training the first generative adversarial network based on the training data to obtain the first generation model. The training the first generative adversarial network based on the training data to obtain the first generation model, includes: inputting the second sample image into the first generative adversarial network to obtain a second actual output image; determining a loss value based on the second actual output image and the second effect image corresponding to the second sample image; and correcting model parameters in the first generative adversarial network based on the loss value, and taking a convergence of a loss function in the first generative adversarial network as a training goal to obtain the first generation model.

It should be noted that, for deployment of the first generation model on the mobile terminal, the first generation model may be obtained by training on the server, and furthermore, the obtained first generation model is deployed to the corresponding mobile terminal according to the target parameter of the mobile terminal. Alternatively, for at least one mobile terminal of the model to be deployed, the model structure of the first generative adversarial network to be trained may be determined according to the target parameter corresponding to the mobile terminal. Further, the first generative adversarial network to be trained may be deployed to the mobile terminal. Furthermore, training data may be obtained based on the mobile terminal, and the first generative adversarial network may be trained based on the training data on the mobile terminal to obtain the first generation model.

In the embodiment of the present disclosure, when the first generation model is obtained, the image to be processed may be input into the first generation model. Furthermore, the image to be processed can be subjected to effect processing based on the first generation model, and an image obtained after the effect processing may be used as a target effect image, and the target effect image may be displayed. The target effect image may be an image that meets effect processing requirements and meets an expected effect. It should be noted that the first generation model corresponds one-to-one to an effect added to the target effect image, that is, the first generation model corresponding to any effect may only output the target effect image corresponding to the effect.

In the embodiment of the present disclosure, the second generation model may be understood as a neural network model deployed on the server, which takes an image as an input object, performs stylized effect processing on the image, and outputs an image with a specific stylized effect. The second generation model may be a neutral network model of any model structure. Optionally, the second generation model may include a convolutional module and a generator in a style-based third generative adversarial network connected to the convolutional module.

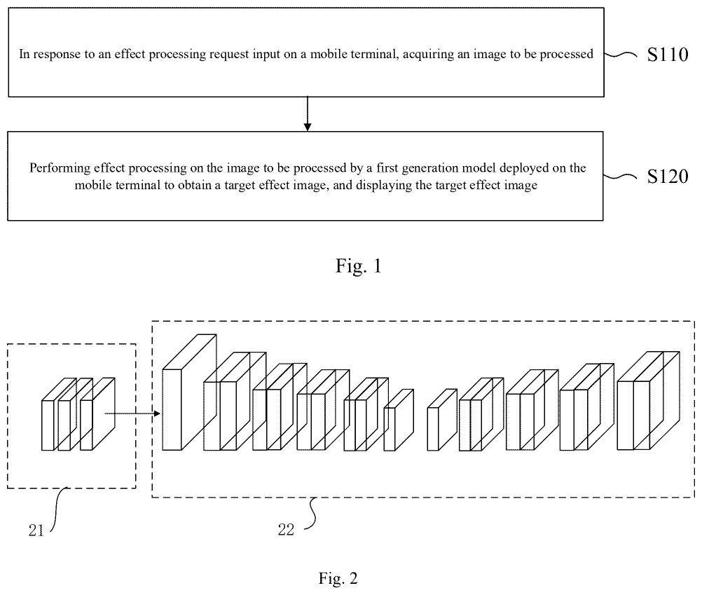

As shown in FIG. 2, a convolutional module 21 may be a neural network model constructed by at least one convolutional layer. The convolutional module may be used as an encoder in the second generation model to extract features from an input image. It may be appreciated that the convolutional module 21 may be configured to extract local image features of the image, and compared with global image features, the local image features have characteristics of being abundant in the image, having low correlation between features, and not affecting detection and matching of other features due to disappearance of some features under occlusion. In addition, the convolutional module 21 is set in the second generation model, and an advantage to take the convolutional module 21 as an encoder is that feature extraction may be performed on the input image to remove redundant image features in the input image, thereby the processing efficiency of the second generation model can be improved, and the image effect of the effect image can be improved.

Continuing with FIG. 2, a generator 22 in the style-based third generative adversarial network may include a mapping module and a compositing module. The mapping module may be specifically configured to map an input random noise vector and an image feature vector output by the convolutional module onto a new latent space through multiple fully connected layers (i.e., a multi-layer perceptron), thereby generating a new latent feature vector. By adding the image features output by the convolutional module, content features in the image composed in the compositing module can be better controlled by the latent feature vector. The mapping module may implement feature decoupling of the random noise vector, so that each dimension or each subspace can control different features of the image. The compositing module includes multiple resolution levels, starting from a very low resolution and gradually increasing to a high resolution. Each resolution level is often composed of multiple style blocks, each of which contains a convolution layer, a normalization layer, and an activation function. The compositing module is configured to gradually generate a high-resolution image based on the latent feature vector output by the mapping module. By applying a normalization layer at each resolution level, the latent feature vector is injected into a generation process, so as to control a style and features of the image. The style-based third generative adversarial network may enable the generator 22 to control and separate the content and the style, thereby implementing more sophisticated and diverse image generation. A content vector determines a theme or basic information of the generated image, such as an outline and facial features of the object; and a style vector may control a texture and a style of details. In the embodiment of the present disclosure, the generator 22 of the style-based third generative adversarial network is used in the second generation model as a decoder, which can implement the control of effect style, so that the second generation model may generate an effect image that meets an expected effect style.

According to an optional implementation of the embodiments of the present disclosure, when the second sample image is obtained, the second sample image may be input into the second generation model. Furthermore, the second sample image is encoded based on the convolutional module in the second generation model to obtain a second sample feature. Furthermore, the second sample feature and a second style vector corresponding to the second sample image may be input into the generator of the style-based third generative adversarial network, so that the generator generates an effect image based on the second sample feature and the second style vector to obtain a second effect image corresponding to the second sample image.

In the embodiment of the present disclosure, in order to adapt the second generation model to the requirements of multiple effects, that is, in order to enable the second generation model to generate effect images with multiple different effects, an output channel of the second generation model may be processed. Optionally, the second generation model includes multiple output channels. A number of output channels included in the second generation model may be associated with a model input. Optionally, when the model input of the second generation model is an image, the second generation model may include six output channels, namely, an image texture channel (including an R channel, a G channel, and a B channel), an image mask layer channel, and a pixel displacement channel (including a pixel horizontal displacement channel and a pixel vertical displacement channel). Output data of the output channel includes at least texture data. The texture data (RGB data) may be data representing texture details of the image. The output data of the output channel also includes image mask data and/or pixel displacement data. The image mask data may be used to indicate an effect region in the output image. The image mask data may be one matrix or array of a same size as an original image, and element values therein may be used to identify whether pixels at corresponding positions need effect processing. The pixel displacement data may be used to represent displacement of each pixel included in the image, that is, displacement of each pixel after being processed by the model. It should be noted that an advantage that the second generation model adopts multiple output channels and the output data of the output channels include texture data, image masking data and/or pixel displacement data, lies in that: by adopting multiple output channels, it achieves an outcome that no matter whether a full-image effect processing or a local effect processing is performed based on the second generation model, the output data of the model output is adapted to a full-image effect or a local effect.

In the embodiment of the present disclosure, the generation model is obtained by training the second generative adversarial network. Before applying the second generation model to generate training data for training the first generation model, the second generative adversarial network pre-established may be trained to obtain the second generation model. A specific training process may be: acquiring a first sample image, and processing the first sample image to obtain a first effect image; training the second generative adversarial network deployed on the server based on the first sample image and its corresponding first effect image to obtain the second generation model. The training the second generative adversarial network deployed on the server based on the first sample image and its corresponding first effect image to obtain the second generation model, includes: inputting the first sample image into the second generative adversarial network, processing the first sample image based on the convolutional module and the generator in the second generative adversarial network to obtain a first actual output image; determining a loss value based on the first actual output image and the first effect image corresponding to the first sample image; and correcting model parameters in the second generative adversarial network based on the loss value, and taking a convergence of a loss function in the second generative adversarial network as a training goal to obtain the second generation model.

In this embodiment, a model loss of the second generation model is determined based on a generation loss of the second generation model and a discrimination loss of a discriminator in the first generative adversarial network; and the generation loss of the second generation model includes a perceptual loss and/or a semantic loss between an output image and an input image of the second generation model. The discrimination loss may be used to measure a prediction accuracy of the discriminator, and may be used to measure a learning ability of the second generation model for effect images. The discrimination loss may be any loss function. Optionally, the discrimination loss may be a cross-entropy loss. The perceptual loss based on vision may be used to evaluate a perceptual similarity between two images. In general, the perceptual loss may be used to evaluate a perceptual difference between two images through a deep learning model (e.g., a discrimination model), which better reflects a visual system's perception of image quality than a traditional pixel-level loss. The perceptual loss uses a pre-trained deep network to extract high-level features of images, which can capture high-level properties of the images such as texture and shape, so as to more accurately evaluate the perceptual similarity between the images. Then, the perceptual loss computes a distance between these features to quantify the perceptual difference between the images.

There are many ways to determine the semantic loss between the output image and the input image. As an optional implementation of the embodiment of the present disclosure, the input image and the output image can be semantically segmented respectively by a pre-trained semantic segmentation model firstly, and then the semantic loss between the input image and the output image is determined according to a semantic segmentation result of the input image and the output image.

In the technical solution of the embodiment of the present disclosure, by responding to an effect processing request input on a mobile terminal, an image to be processed is acquired; the image to be processed is acquired on the mobile terminal, so as to improve an acquisition efficiency of the image to be processed, and provide a data basis for subsequent effect processing; and by initiating the effect processing request through the mobile terminal, the application object of effects can be wider; furthermore, by performing effect processing on the image to be processed by a first generation model deployed on the mobile terminal to obtain a target effect image, and displaying the target effect image, because the first generation model is obtained by training a first generative adversarial network, at least part of training data of the first generative adversarial network is generated by a second generation model deployed on a server, and the second generation model is obtained by training a second generative adversarial network. Compared with a client, the server can support more complex effect processing and support training of a larger amount of data for the second generation model. By generating the training data of the first generative adversarial network by the second generation model deployed on the server, the quality of the training data is ensured so as to further improve an effect processing accuracy of the first generation model, the problems in the related art of a slow response rate of the mobile terminal to the effect processing request and a poor effect of the obtained effect image are solved, an effect that the first generation model deployed on the mobile terminal can implement complex effects is achieved, and a response efficiency of the effect request is improved, so that effect processing can be completed more quickly and effect images can be presented.

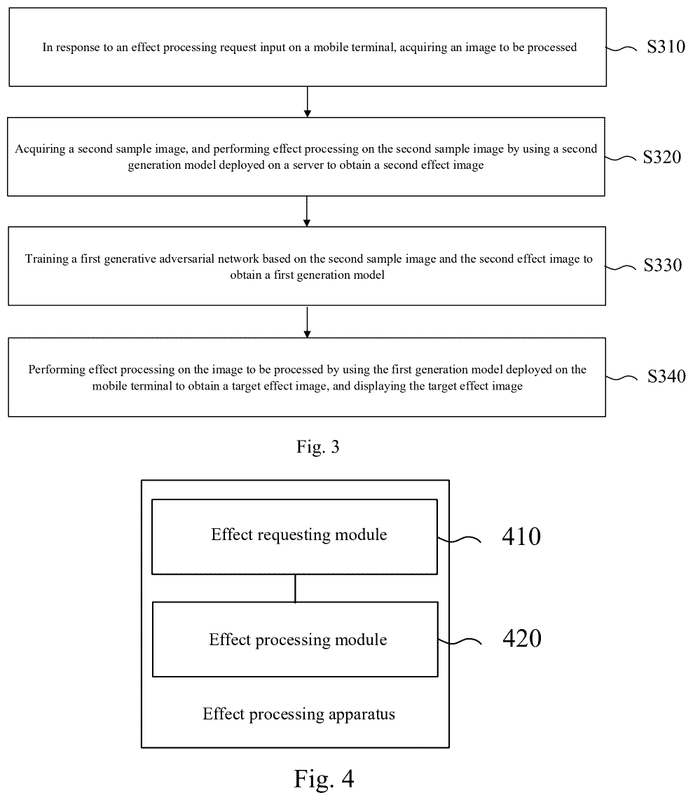

FIG. 3 is a flow chart of another effect processing method according to an embodiment of the present disclosure. The technical solution of this embodiment involves, based on the above embodiment, before performing effect processing on the image to be processed by the first generation model deployed on the mobile terminal, acquiring a second sample image, and performing effect processing on the second sample image by using the second generation model to obtain a second effect image; and based on the second sample image and the second effect image, training the first generative adversarial network to obtain the first generation model. For a specific implementation mode, please refer to the description of this embodiment. The technical features that are the same or similar to the above embodiment are not repeated here.

As shown in FIG. 3, the method of this embodiment may specifically include steps S310, S320, S330 and S340.

At S310, in response to an effect processing request input on a mobile terminal, acquiring an image to be processed.

At S320, acquiring a second sample image, and performing effect processing on the second sample image by using the second generation model deployed on a server to obtain a second effect image.

The second sample image may be understood as an image captured by a camera device, or an image reconstructed by an image reconstruction model, or an image pre-stored in a storage space. The second effect image may be an effect image generated after the second sample image is subjected to effect processing based on the second generation model.

In the embodiment of the present disclosure, the second generation model is obtained by training the second generative adversarial network. Before performing effect processing on the second sample image by using the second generation model, the method further includes: generating a first sample image by a third generation model deployed on the server, and processing the first sample image to obtain a first effect image; training the second generative adversarial network deployed on the server by using the first sample image and its corresponding first effect image to obtain the second generation model.

The third generation model may be understood as a neural network model that takes an image as an input object, performs stylized effect processing on the image, and outputs an image with a specific stylized effect. The third generation model may be a neural network model of any model structure. For example, the first generation model may be a stable diffusion model. The stable diffusion model is an image generation model based on a diffusion process, which may generate high-quality and high-resolution images, and is a relatively new diffusion model. A core idea of stable diffusion is to gradually approach a real image by continuously adjusting an implicit representation of the image. In the embodiment of the present disclosure, the third generation model is obtained by training the diffusion model.

In the embodiment of the present disclosure, the generating the first sample image by the third generation model deployed on the server may include multiple implementation modes. Optionally, a text feature vector and a noise vector may be input into the third generation model so that the text feature vector and the noise vector are processed based on the third generation model, and an image output by the model is used as the first sample image. Alternatively, an image feature vector and a noise vector are input into the third generation model, so that the image feature vector and the noise vector are processed based on the third generation model, and an image output by the model is used as the first sample image. Alternatively, an audio feature vector and a noise vector may be input into the third generation model so that the audio feature vector and the noise vector are processed based on the third generation model, and an image output by the model is used as the first sample image.

In the embodiment of the present disclosure, when the first sample image is obtained, effect processing may be performed on the first sample image according to a preset effect processing manner, to obtain a first effect image.

In a practical application, different first sample images may include different image contents. When the different first sample images are subjected to effect processing by using the same effect processing manner, effect probability distribution of the obtained effect images may be inconsistent. Further, it may cause the trained second generation model to be unstable in model processing result and difficult to converge when using such training data to train the second generative adversarial network.

In view of the above case, in the embodiment of the present disclosure, for first sample images with different image contents, different effect processing manners may be used to perform effect processing on the corresponding first sample images to obtain first effect images.

Optionally, the processing the first sample image to obtain a first effect image, includes: determining an image category corresponding to the first sample image; determining an effect processing manner according to the image category, and processing the first sample image to obtain a first effect image by using the effect processing manner.

The image category is associated with attribute data of image contents subjected to effect processing in the first sample image. The attribute data may be understood as data used to represent specific features exhibited by the image content. For example, assuming that the image content to be subjected to effect processing is a face of the object in the first sample image, its corresponding attribute data may be data representing facial features in different attribute dimensions; assuming that the image content to be subjected to effect processing is an entire image content in the first sample image, its corresponding attribute data may be data representing the first sample image in different attribute dimensions. Different image categories may correspond to different effect processing manners. The effect processing manners may include a variety of manners for performing effect processing on an image. Optionally, the effect processing manner may include an effect processing algorithm and/or effect processing based on a neural network model.

As an optional implementation of the embodiment of the present disclosure, multiple image categories and an effect processing manner corresponding to each image category may be predetermined, and a mapping relationship between the image category and the corresponding effect processing manner can be established. Further, when the first sample image is obtained, the image content to be subjected to effect processing in the first sample image may be determined. Furthermore, an image category corresponding to the first sample image may be determined according to the attribute data of the image content. Further, an effect processing manner corresponding to the image category may be determined according to the pre-established mapping relationship. Furthermore, the effect processing manner may be used to perform effect processing on the first sample image to obtain a first effect image.

In the embodiment of the present disclosure, when the first sample image and its corresponding first effect image are obtained, the first sample image and its corresponding first effect image may be used to train the second generative adversarial network deployed on the server.

It should be noted that, in order to enable sufficient training data for a subsequent model training of the first generation model, the third generation model often generates a large number of first sample images, and further may obtain a large number of first effect images. Among these large number of first sample images and first effect images, there may be a case where the image quality of the generated first sample image is low and/or the image quality of the obtained first effect image is low. Moreover, the requirement of second generation model for the amount of training data will be reduced. Thus, in order to improve the model processing effect and model processing stability of the second generation model, the first sample image and/or the first effect image may be selected to filtering out images with low image quality. Furthermore, the second generative adversarial network is trained based on the selected first sample image and the first effect image to obtain the second generation model.

Optionally, the training the second generative adversarial network deployed on the server by using the first sample image and the first effect image corresponding to the first sample image, includes: selecting the first sample image and/or the first effect image, determining a plurality of groups of paired data according to a selecting result, and taking the plurality of groups of paired data as training data to train the second generative adversarial network deployed on the server.

As an optional implementation of the embodiment of the present disclosure, the selecting the first sample image and/or the first effect image, determining a plurality of groups of paired data according to a selecting result, includes: selecting the first sample image according to a preset first selecting manner, and filtering out first effect image corresponding to the filtered out first sample image; constructing a plurality of groups of paired data based on the remaining first sample images and their corresponding first effect images.

Optionally, the first selecting manner may include manual selecting and/or automatic selecting based on at least one preset first image quality index. The first image quality index may be used to evaluate the image quality of the first sample image. Optionally, the first image quality indicator may include image clarity, image content fit and/or image resolution, etc. For example, the first sample images may be selected according to at least one first image quality indicator, and a first sample image that does not reach a standard value corresponding to the first image quality index in the first sample images is filtered out.

As another optional implementation of the embodiment of the present disclosure, the selecting the first sample image and/or the first effect image, determining a plurality of groups of paired data according to a selecting result, includes: selecting the first effect image according to a preset second selecting manner, and filtering out a first sample image corresponding to the filtered out first effect image; constructing a plurality of groups of paired data based on the remaining first effect images and their corresponding first sample images.

Optionally, the second selecting manner may include manual selecting and/or automatic selecting based on at least one preset second image quality index. The second image quality index may be used to evaluate the image quality of the first effect image. Optionally, the second image quality index may include image clarity, image resolution, peak signal-to-noise ratio and/or mean squared error. For example, the first effect image may be selected according to at least one second image quality index, and a first effect image that does not reach a standard value corresponding to the second image quality index in the first effect images is filtered out.

As another optional implementation of the embodiment of the present disclosure, the selecting the first sample image and/or the first effect image, determining a plurality of groups of paired data according to a selecting result, includes: selecting the first sample image according to a preset first selecting manner, and filtering out a first effect image corresponding to the filtered out first sample image; selecting the remaining first effect image after filtering out first effect images according to a preset second selecting method, and filtering out a first sample image corresponding to the filtered out first effect image; constructing multiple groups of paired data based on the remaining first effect image and its corresponding first sample image after selecting and removing. The paired data is training data of the first effect image including the first sample image and the first effect image corresponding to the first sample image.

In the embodiment of the present disclosure, after the plurality of groups of paired data are obtained, the plurality of groups of paired data may be used as training data, and the second generative adversarial network deployed on the server may be trained based on the training data to obtain the second generation model. Further, a second sample image may be acquired, and the second sample image is input into the second generation model, so that effect processing is performed on the second sample image based on the second generation model, and a second effect image is output.

At S330, training the first generative adversarial network based on the second sample image and the second effect image to obtain a first generation model.

In the embodiment of the present disclosure, the second sample image may be input into the first generative adversarial network, so as to perform effect processing on the second sample image based on the first generative adversarial network to obtain a second actual output image. Further, loss processing may be performed based on the second actual output image and the second effect image corresponding to the second sample image to obtain a loss value; based on the loss value, model parameters in the first generative adversarial network are corrected, and convergence of a loss function in the first generative adversarial network is used as a training target to obtain the first generation model. It should be noted that the training of the first generative adversarial network may be performed on the server or on the client. Which manner is specially adopted may be set according to needs, which is not specifically limited here.

At S340, performing effect processing on the image to be processed by using the first generation model deployed on the mobile terminal to obtain a target effect image, and displaying the target effect image.

In the technical solution of the embodiment of the present disclosure, by acquiring a second sample image, and performing effect processing on the second sample image by using the second generation model to obtain a second effect image, and further based on the second sample image and the second effect image, training the first generative adversarial network to obtain the first generation model, it achieves an effect of generating training data for training the first adversarial network based on the second generation model deployed on the server, improves a generation efficiency of the training data, and improves data distribution consistency of the training data, thereby improving a model performance of the first generation model.

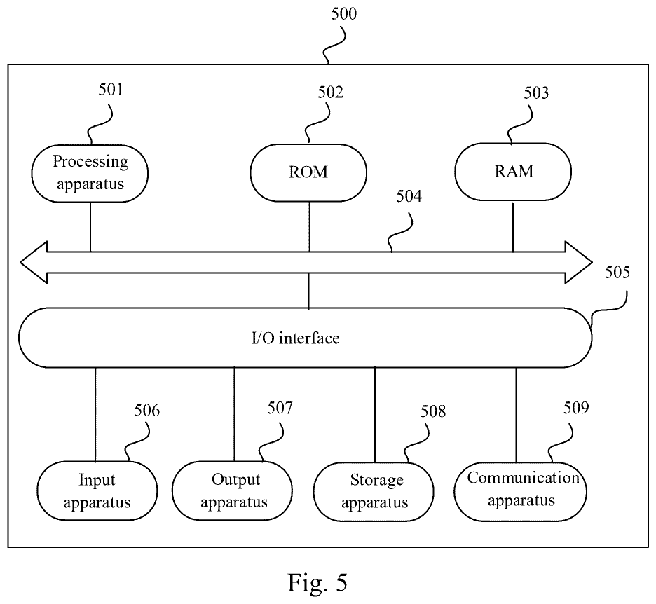

FIG. 4 is a structural schematic diagram of an effect processing apparatus according to an embodiment of the present disclosure. As shown in FIG. 4, the apparatus includes: an effect requesting module 410 and an effect processing module 420.

The effect requesting module 410 is configured to, in response to an effect processing request input on a mobile terminal, acquire an image to be processed; the effect processing module 420 is configured to perform effect processing on the image to be processed by a first generation model deployed on the mobile terminal to obtain a target effect image, and display the target effect image; the first generation model is obtained by training a first generative adversarial network, at least part of training data of the first generative adversarial network is generated by a second generation model deployed on a server, and the second generation model is obtained by training a second generative adversarial network.

On the basis of the above optional technical solutions, optionally, the apparatus further includes: a sample image acquiring module and a first generation model determining module. The sample image acquiring module is configured to, before the performing effect processing on the image to be processed by a first generation model deployed on the mobile terminal, acquire a second sample image, and perform effect processing on the second sample image by using the second generation model to obtain a second effect image; the first generation model determining module is configured to, based on the second sample image and the second effect image, train the first generative adversarial network to obtain the first generation model.

On the basis of the above optional technical solutions, optionally, the apparatus further includes: an image generating module and a second generation model determining module. The image generating module is configured to, before performing effect processing on the second sample image by using the second generation model, generate a first sample image by a third generation model deployed on the server, and process the first sample image to obtain a first effect image, the third generation model is obtained by training a diffusion model; and the second generation model determining module is configured to train the second generative adversarial network deployed on the server by using the first sample image and its corresponding first effect image to obtain the second generation model.

On the basis of the above optional technical solutions, optionally, the image generating module includes: an image category determining unit and an image processing unit. The image category determining unit is configured to determine an image category corresponding to the first sample image, the image category is associated with attribute data of image content subjected to effect processing in the first sample image; and the image processing unit is configured to determine an effect processing manner according to the image category and process the first sample image to obtain a first effect image by using the effect processing manner.

On the basis of the above optional technical solutions, optionally, the second generation model determining module is specifically configured to select the first sample image and/or the first effect image, determine a plurality of groups of paired data according to a selecting result, and take the plurality of groups of paired data as training data to train the second generative adversarial network deployed on the server; the paired data is training data including the first sample image and the first effect image corresponding to the first sample image.

On the basis of the above optional technical solutions, optionally, the second generation model includes a convolutional module and a generator in a style-based third generative adversarial network connected to the convolutional module.

On the basis of the above optional technical solutions, optionally, the second generation module includes a plurality of output channels; output data of the output channel at least includes texture data; and the output data of the output channel further includes image mask data and/or pixel displacement data

On the basis of the above optional technical solutions, optionally, a model loss of the second generation model is determined based on a generation loss of the second generation model and a discrimination loss of a discriminator in the first generative adversarial network; and the generation loss of the second generation model includes a perceptual loss and/or a semantic loss between an output image and an input image of the second generation model.

On the basis of the above optional technical solutions, optionally, a model structure of the first generation model is associated based on a target parameter of the mobile terminal; the target parameter is used for representing a computing power of the mobile terminal; and the target parameter at least includes an image resolution corresponding to the mobile terminal and/or a number of floating-point operations performed per second.

In the technical solution of the embodiment of the present disclosure, by responding to an effect processing request input on a mobile terminal, the effect requesting module 410 acquires an image to be processed; the image to be processed is acquired on the mobile terminal, so as to improve an acquisition efficiency of the image to be processed, and provide a data basis for subsequent effect processing; and by initiating the effect processing request through the mobile terminal, the application object of effects may be wider; furthermore, based on the effect processing module 420 performing effect processing on the image to be processed by a first generation model deployed on the mobile terminal to obtain a target effect image, and displaying the target effect image, because the first generation model is obtained by training a first generative adversarial network, at least part of training data of the first generative adversarial network is generated by a second generation model deployed on a server, and the second generation model is obtained by training a second generative adversarial network. Compared with a client, the server can support more complex effect processing and support training of a larger amount of data for the second generation model. By generating the training data of the first generative adversarial network by the second generation model deployed on the server, the quality of the training data is ensured so as to further improve an effect processing accuracy of the first generation model, the problems in the related art of a slow response rate of the mobile terminal to the effect processing request and a poor effect of the obtained effect image are solved, an effect that the first generation model deployed on the mobile terminal can implement complex effects is achieved, and a response efficiency of the effect request is improved, so that effect processing can be completed more quickly and effect images can be presented.

The effect processing apparatus according to the embodiment of the present disclosure may perform the effect processing method according to any embodiment of the present disclosure, and has corresponding functional modules to perform the method as well as beneficial effects.

It is worth noting that each unit and module included in the above device is only divided according to functional logic, but it is not limited to the above division, as long as the corresponding functions can be realized; in addition, the specific names of each functional unit are only for the convenience of distinguishing each other, and are not used to limit the protection scope of the embodiments of the present disclosure.

FIG. 5 is a schematic structural diagram of an electronic device according to an embodiment of the present disclosure. Referring to FIG. 5, FIG. 5 illustrates a schematic structural diagram of an electronic device 500 (for example, a terminal device or a server in FIG. 5) suitable for implementing some embodiments of the present disclosure. The terminal devices in some embodiments of the present disclosure may include but are not limited to mobile terminals such as a mobile phone, a notebook computer, a digital broadcasting receiver, a personal digital assistant (PDA), a portable Android device (PAD), a portable media player (PMP), a vehicle terminal (e.g., a vehicle navigation terminal) or the like, and fixed terminals such as a digital TV, a desktop computer, or the like. The electronic device illustrated in FIG. 5 is merely an example, and should not pose any limitation to the functions and the range of use of the embodiments of the present disclosure.

As illustrated in FIG. 5, the electronic device 500 may include a processing apparatus (e.g., a central processing unit, a graphics processing unit, etc.) 501, which can perform various suitable actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An editing/output (I/O) interface 505 is also connected to the bus 504.

Usually, the following apparatus may be connected to the I/O interface 505: an input apparatus 506 including, for example, a touch screen, a touch pad, a keyboard, a mouse, a camera, a microphone, an accelerometer, a gyroscope, or the like; an output apparatus 507 including, for example, a liquid crystal display (LCD), a loudspeaker, a vibrator, or the like; a storage apparatus 508 including, for example, a magnetic tape, a hard disk, or the like; and a communication apparatus 509. The communication apparatus 509 may allow the electronic device 500 to be in wireless or wired communication with other devices to exchange data. While FIG. 5 illustrates the electronic device 500 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a non-transitory computer-readable medium. The computer program includes program codes for performing the methods shown in the flowcharts. In such embodiments, the computer program may be downloaded online through the communication apparatus 509 and installed, or may be installed from the storage apparatus 508, or may be installed from the ROM 502. When the computer program is executed by the processing apparatus 501, the above-mentioned functions defined in the methods of embodiments of the present disclosure are performed.

Names of messages or information exchanged among multiple devices in the embodiment of the present disclosure are only used for illustrative purposes, and are not used to limit the scope of these messages or information.

The electronic device according to the embodiments of this disclosure belongs to the same inventive concept as the effect processing method according to the above embodiments, and the technical details not described in detail in this embodiment can be found in the above embodiments, and this embodiment has the same beneficial effects as the above embodiments.

An embodiment of the present disclosure provides a computer storage medium, on which a computer program is stored, which, when executed by a processor, realizes the effect processing method according to the above embodiments.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any appropriate combination thereof. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program codes contained on the computer-readable medium may be transmitted by using any suitable medium, including but not limited to an electric wire, a fiber-optic cable, radio frequency (RF) and the like, or any appropriate combination thereof.

In some embodiments, the mobile terminal and the server may communicate with any network protocol currently known or to be researched and developed in the future such as Hyper Text Transfer Protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The above-mentioned computer-readable medium carries one or more programs, and when the one or more programs are executed by the electronic device, the electronic device is caused to: in response to an effect processing request input on a mobile terminal, acquiring an image to be processed; and performing effect processing on the image to be processed by a first generation model deployed on the mobile terminal to obtain a target effect image, and displaying the target effect image; where the first generation model is obtained by training a first generative adversarial network, at least part of training data of the first generative adversarial network is generated by a second generation model deployed on a server, and the second generation model is obtained by training a second generative adversarial network.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or the like. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or may be connected to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. Among them, the name of the unit does not constitute a limitation of the unit itself under certain circumstances, for example, the first obtaining unit can also be described as “a unit that obtains at least two Internet protocol addresses”.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semiconductor system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the disclosure, an effect processing method including: in response to an effect processing request input on a mobile terminal, acquiring an image to be processed; and performing effect processing on the image to be processed by a first generation model deployed on the mobile terminal to obtain a target effect image, and displaying the target effect image; the first generation model is obtained by training a first generative adversarial network, at least part of training data of the first generative adversarial network is generated by a second generation model deployed on a server, and the second generation model is obtained by training a second generative adversarial network.

According to one or more embodiments of the disclosure, the method further includes:
optionally, before performing the effect processing on the image to be processed by the first generation model deployed on the mobile terminal, further including: acquiring a second sample image, and performing effect processing on the second sample image by using the second generation model to obtain a second effect image; and based on the second sample image and the second effect image, training the first generative adversarial network to obtain the first generation model.

According to one or more embodiments of the disclosure, the method further includes:
optionally, before performing the effect processing on the second sample image by using the second generation model, further including: generating a first sample image by a third generation model deployed on the server, and processing the first sample image to obtain a first effect image, the third generation model is obtained by training a diffusion model; and training the second generative adversarial network deployed on the server by using the first sample image and the first effect image corresponding to the first sample image to obtain the second generation model.

According to one or more embodiments of the disclosure, the method further includes:
optionally, the processing the first sample image to obtain the first effect image includes: determining an image category corresponding to the first sample image, the image category is associated with attribute data of image content subjected to the effect processing in the first sample image; and determining an effect processing manner according to the image category, and processing the first sample image to obtain a first effect image by using the effect processing manner.

According to one or more embodiments of the disclosure, the method further includes:
optionally, the training the second generative adversarial network deployed on the server by using the first sample image and the first effect image corresponding to the first sample image, includes: selecting the first sample image and/or the first effect image, determining a plurality of groups of paired data according to a selecting result, and taking the plurality of groups of paired data as training data to train the second generative adversarial network deployed on the server; the paired data is training data including the first sample image and the first effect image corresponding to the first sample image.

According to one or more embodiments of the disclosure, the method further includes:
optionally, the second generation module includes a convolutional module and a generator in a style-based third generative adversarial network connected to the convolutional module.

According to one or more embodiments of the disclosure, the method further includes:
optionally, the second generation module includes a plurality of output channels; output data of the output channel at least includes texture data; and the output data of the output channel further includes image mask data and/or pixel displacement data.

According to one or more embodiments of the disclosure, the method further includes:
optionally, a model loss of the second generation model is determined based on a generation loss of the second generation model and a discrimination loss of a discriminator in the first generative adversarial network; and the generation loss of the second generation model includes a perceptual loss and/or a semantic loss between an output image and an input image of the second generation model.

According to one or more embodiments of the disclosure, the method further includes:
optionally, a model structure of the first generation model is associated based on target parameter of the mobile terminal; the target parameter is used for representing a computing power of the mobile terminal; and the target parameter at least includes an image resolution corresponding to the mobile terminal and/or a number of floating-point operations performed per second.

According to one or more embodiments of the disclosure, an effect processing apparatus includes: an effect requesting module, configured to, in response to an effect processing request input on a mobile terminal, acquire an image to be processed; an effect processing module, configured to perform effect processing on the image to be processed by a first generation model deployed on the mobile terminal to obtain a target effect image, and display the target effect image; the first generation model is obtained by training a first generative adversarial network, at least part of training data of the first generative adversarial network is generated by a second generation model deployed on a server, and the second generation model is obtained by training a second generative adversarial network.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the above disclosure concept. For example, the technical features described above may be mutually replaced with the technical features having similar functions disclosed herein (but not limited thereto) to form new technical solutions.

In addition, while operations have been described in a particular order, it shall not be understood as requiring that such operations are performed in the illustrated specific order or sequence. Under certain circumstances, multitasking and parallel processing may be advantageous. Similarly, while some specific implementation details are included in the above discussions, these shall not be construed as limitations to the scope of the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. An effect processing method, comprising:
in response to an effect processing request input on a mobile terminal, acquiring an image to be processed; and
performing effect processing on the image to be processed by a first generation model deployed on the mobile terminal to obtain a target effect image, and displaying the target effect image,
wherein the first generation model is obtained by training a first generative adversarial network, at least part of training data of the first generative adversarial network is generated by a second generation model deployed on a server, and the second generation model is obtained by training a second generative adversarial network.

2. The effect processing method according to claim 1, before performing the effect processing on the image to be processed by the first generation model deployed on the mobile terminal, further comprising:
acquiring a second sample image, and performing effect processing on the second sample image by using the second generation model to obtain a second effect image; and
based on the second sample image and the second effect image, training the first generative adversarial network to obtain the first generation model.

3. The effect processing method according to claim 2, before performing the effect processing on the second sample image by using the second generation model, further comprising:
generating a first sample image by a third generation model deployed on the server, and processing the first sample image to obtain a first effect image, wherein the third generation model is obtained by training a diffusion model; and
training the second generative adversarial network deployed on the server by using the first sample image and the first effect image corresponding to the first sample image to obtain the second generation model.

4. The effect processing method according to claim 3, wherein the processing the first sample image to obtain the first effect image, comprises:
determining an image category corresponding to the first sample image, wherein the image category is associated with attribute data of image content subjected to the effect processing in the first sample image; and
determining an effect processing manner according to the image category, and processing the first sample image to obtain a first effect image by using the effect processing manner.

5. The effect processing method according to claim 3, wherein the training the second generative adversarial network deployed on the server by using the first sample image and the first effect image corresponding to the first sample image, comprises:
selecting at least one of the group consisting of the first sample image and the first effect image, determining a plurality of groups of paired data according to a selecting result, and taking the plurality of groups of paired data as training data to train the second generative adversarial network deployed on the server,
wherein the paired data is training data comprising the first sample image and the first effect image corresponding to the first sample image.

6. The effect processing method according to claim 1, wherein the second generation module comprises a generator in a style-based third generative adversarial network and a convolutional module, wherein the generator is connected to the convolutional module.

7. The effect processing method according to claim 1, wherein the second generation module comprises a plurality of output channels;
output data of the output channels at least comprises texture data; and
the output data of the output channels further comprises at least one of the group consisting of image mask data and pixel displacement data.

8. The effect processing method according to claim 1, wherein a model loss of the second generation model is determined based on a generation loss of the second generation model and a discrimination loss of a discriminator in the first generative adversarial network; and
the generation loss of the second generation model comprises at least one of the group consisting of a perceptual loss and a semantic loss between an output image and an input image of the second generation model.

9. The effect processing method according to claim 1, wherein a model structure of the first generation model is associated based on a target parameter of the mobile terminal;
the target parameter is used for representing a computing power of the mobile terminal; and
the target parameter at least comprises at least one of the group consisting of an image resolution corresponding to the mobile terminal and a number of floating-point operations performed per second corresponding to the mobile terminal.

10. The effect processing method according to claim 5, wherein, upon detecting a trigger operation input for an effect processing control preset on the mobile terminal, determining that the effect processing request input on the mobile terminal is received.

11. An electronic device, comprising:
one or more processors;
a storage apparatus configured to store one or more programs,
wherein the one or more programs, when executed by the one or more processors, cause the one or more processors to implement an effect processing method,
wherein the effect processing method comprises:
in response to an effect processing request input on a mobile terminal, acquiring an image to be processed; and
performing effect processing on the image to be processed by a first generation model deployed on the mobile terminal to obtain a target effect image, and displaying the target effect image,
wherein the first generation model is obtained by training a first generative adversarial network, at least part of training data of the first generative adversarial network is generated by a second generation model deployed on a server, and the second generation model is obtained by training a second generative adversarial network.

12. The electronic device according to claim 11, wherein before performing the effect processing on the image to be processed by the first generation model deployed on the mobile terminal, the method further comprising:
acquiring a second sample image, and performing effect processing on the second sample image by using the second generation model to obtain a second effect image; and
based on the second sample image and the second effect image, training the first generative adversarial network to obtain the first generation model.

13. The electronic device according to claim 12, wherein before performing the effect processing on the second sample image by using the second generation model, the effect processing method further comprising:
generating a first sample image by a third generation model deployed on the server, and processing the first sample image to obtain a first effect image, wherein the third generation model is obtained by training a diffusion model; and
training the second generative adversarial network deployed on the server by using the first sample image and the first effect image corresponding to the first sample image to obtain the second generation model.

14. The electronic device according to claim 13, wherein the processing the first sample image to obtain the first effect image, comprises:
determining an image category corresponding to the first sample image, wherein the image category is associated with attribute data of image content subjected to the effect processing in the first sample image; and
determining an effect processing manner according to the image category, and processing the first sample image to obtain a first effect image by using the effect processing manner.

15. The electronic device according to claim 13, wherein the training the second generative adversarial network deployed on the server by using the first sample image and the first effect image corresponding to the first sample image, comprises:
selecting at least one of the group consisting of the first sample image and the first effect image, determining a plurality of groups of paired data according to a selecting result, and taking the plurality of groups of paired data as training data to train the second generative adversarial network deployed on the server,
wherein the paired data is training data comprising the first sample image and the first effect image corresponding to the first sample image.

16. The electronic device according to claim 11, wherein the second generation module comprises a generator in a style-based third generative adversarial network and a convolutional module, wherein the generator is connected to the convolutional module.

17. The electronic device according to claim 11, wherein the second generation module comprises a plurality of output channels;
output data of the output channels at least comprises texture data; and
the output data of the output channels further comprises at least one of the group consisting of image mask data and pixel displacement data.

18. The electronic device according to claim 11, wherein a model loss of the second generation model is determined based on a generation loss of the second generation model and a discrimination loss of a discriminator in the first generative adversarial network; and
the generation loss of the second generation model comprises at least one of the group consisting of a perceptual loss and a semantic loss between an output image and an input image of the second generation model.

19. The electronic device according to claim 11, wherein a model structure of the first generation model is associated based on a target parameter of the mobile terminal;
the target parameter is used for representing a computing power of the mobile terminal; and
the target parameter at least comprises at least one of the group consisting of an image resolution corresponding to the mobile terminal and a number of floating-point operations performed per second corresponding to the mobile terminal.

20. A non-transitory storage medium containing computer-executable instructions, wherein the computer-executable instructions, when executed by a computer processor, perform an effect processing method,
wherein the effect processing method comprises:
in response to an effect processing request input on a mobile terminal, acquiring an image to be processed; and
performing effect processing on the image to be processed by a first generation model deployed on the mobile terminal to obtain a target effect image, and displaying the target effect image,
wherein the first generation model is obtained by training a first generative adversarial network, at least part of training data of the first generative adversarial network is generated by a second generation model deployed on a server, and the second generation model is obtained by training a second generative adversarial network.
